(19) United States
(12) Patent Application Publication
(10) Pub. No.: US 2004/0065249 A1
(43) Pub. Date: Apr. 8, 2004

(54) Vehicle direction signal device

(76) Inventor: George L. Williams, San Antonio, TX (US)

Correspondence Address: Janice Leverett, 5650 Grissom Rd # 406, San Antonio, TX, 78238, US

(21) Appl. No.: 10/620,848

(22) Filed: Jul. 16, 2003

Related U.S. Application Data
(63) Continuation-in-part of application No. 10/176,996, filed on Jun. 21, 2002, now abandoned.
(60) Provisional application No. 60/299,872, filed on Jun. 21, 2001.

(51) Int. Cl. B60Q 1/26

(52) U.S. Cl. 116/35 R

(57) ABSTRACT

A vehicle direction indicator system is designed to alert surrounding drivers of the intentions of the vehicle operator. The indicator system has a plurality of end points and each end point is powered by the vehicle's electrical system and includes a housing, a light source holder and a lens attached to the front portion of the housing. The end points may be positioned in various locations such as the grill, spoiler, side markers and the like and may simultaneously emit a color when the vehicle driver actuates the indicator system within the vehicle. The system is preferably mounted onto the front portion of the vehicle and is capable of telling other drivers at a four way intersection that the signaling device is about to continue in a straight direction.

### PRIOR PATENT APPLICATIONS

This paper is a continuation-in-part application based upon a parent utility application having the Ser. No. 10/176,996 filed on Jun. 21, 2002 relating back to a provisional patent application having the serial No. 60/299,872 filed on Jun. 21, 2001 and incorporated in its entirety.

### TECHNICAL FIELD

The present invention relates generally to a signaling device, namely to a vehicle direction signaling device to indicate a vehicle proceeding in a straightforward direction.

### BACKGROUND OF THE INVENTION

Signaling devices designed for motor vehicles are well known in the art. Since the earliest days of the automobile and other motorized vehicles, various indicator lights were added to the outside surface of the vehicle, activated by the driver, to warn other drivers of his or her intentions. Brake lights, turn signals, reverse lights and hazard warning flashes are conventional examples of such indication devices. These indicators are generally powered by a vehicle's electrical system, and the brake lights are red in color, the turn signals and hazard signals are amber in color and the reverse lights are typically white in color.

There is, however, a driving condition that can cause confusion to other drivers and that does not currently have an indicator to give notice of the condition. The condition normally occurs when a driver arrives at a four way intersection along with one or more drivers that approach the same direction. A conscientious driver will use his or her turn signal to indicate a turn, however, a less conscientious driver may neglect to do so. Although the drivers need to signal their intentions to one another, there is no adequate signal for proceeding in a straight forward direction. In the spirit of driving defensively, it would be advantageous for a driver to have an additional indicator that would signal to other drivers that the driver intends to proceed in a straight ahead direction.

In the past decade, a number of advancements have occurred in the automobile industry. An example of such an advancement is seen in U.S. Pat. No. 5,731,755 (hereinafter the '755 patent) issued to Boxer on Mar. 24, 1998. The '755 patent discloses an indicator for designating a U-turn attempt having a series of sequentially illuminated lights forming the shape of the letter U. The U-turn indicator is activated by an actuator and a control module responds to the actuator and generates a control signal, thereby sequentially illuminating the series of lights. However, the '755 patent only provides for a U-turn indicator and fails to address a directional signal used when a driver is proceeding in a straight ahead direction.

Another advancement is depicted in U.S. Pat. No. 5,845,990 (hereinafter the '990 patent) issued to Hymer on Dec. 8, 1998. The '990 patent is a device for an automotive vehicle used during signal braking, deceleration, turning of the vehicle or an emergency situation. The device has two bodies facing rearwardly, mounted near the top of the back or the highest point of the vehicle adjacent the sides of the vehicle. Each body has a base and a cover with translucent lenses. Here, the light sources and reflectors are disposed on the base for illuminating the lenses to create the signaling as required. Specifically, lighting one or more lenses in the cover indicate braking while lighting an arrow shaped lens in the cover and a side lens facing out from the vehicle indicate intended turning. Although the '990 patent indicates when a driver intends to brake or make a left turn or right turn, it expressly fails to provide for a signaling device designed to indicate when a driver is proceeding in a straight forward direction.

Another advancement was the incorporation of a vehicle signal light assembly that conveys a plurality of messages to pedestrians and/or occupants of other vehicles as described in U.S. Pat. No. 6,515,583 (hereinafter the '583 patent). The '583 patent discloses a vehicle signal light assembly having a housing base which supports at least two circuit boards and a transparent or translucent cover to protect the circuit boards. Each circuit board carries light emitting diodes (LEDs) arranged to convey at least one message. In particular, the assembly can convey a word or symbol message in a horizontal orientation while the assembly is easily adapted for installation in a variety of orientations including right hand and left hand orientations. However, the '583 patent fails to claim and teach a vehicle signal device alerting surrounding vehicles of the driver's intention of proceeding in a straight forward direction.

In view of the above described deficiencies associated with the use of conventional vehicle indicator signal devices, the present invention has been developed to alleviate these drawbacks and provide further benefits to a user. The present invention and its benefits are described in greater detail herein below with respect to several alternative embodiments of the present invention.

### SUMMARY OF THE INVENTION

The present invention in its several disclosed embodiments alleviates the drawbacks described above with respect to vehicle signaling devices and incorporates several additionally beneficial features. The present invention described herein is a vehicle signal device allowing nearby motorists to know that the vehicle is about to continue in a straight ahead direction. Here, the present invention comprises an indicator system having at least one indicator, preferably a plurality of indicators positioned on various locations on a vehicle, designed to signal a straight ahead direction.

Each indicator generally includes a light source holder, a light source and a housing having a base and a lens being connected to one another by at least one fastener. The base has a perimeter wall which surrounds a cavity therein. The cavity holds the light source holder therein and has an aperture allowing wiring from the light source holder to exit the base and be connected to a signaling device.

The signaling device is activated by the driver through a switch connected to a turn indicator stem or other device. The switch sends an electrical current to the light source allowing the light source to be turned on. The light source may be connected to a flasher unit allowing the light source to emit intermittent light. The signaling device may be deactivated either manually or automatically by a mechanism.

An advantage of the present invention is to prevent automotive accidents and reduce medical and automotive insurance rates by adding an indicator signaling a driver's intention of proceeding in a straight ahead manner. The indicators in the system may be placed in a variety of different locations on the vehicle allowing for high visibility. Further, the visibility of the indicator system is increased by incorporating lens(es) tinted in color.

The signaling device of the present invention is capable of being activated by different means such as voice, GPS, hand or foot. These activation means allows human operators to overcome any physical disabilities and still maintain a sense of safety for themselves and surrounding drivers.

Further, the present invention allows for solar powered cells to be incorporated either in the housing or onto the lens. These cells allow for the present invention to be operated in an environmental-friendly and cost efficient manner.

Other objects and advantages of the present invention will become apparent from the following descriptions, taken in connection with the accompanying drawings, wherein by way of illustration and example, an embodiment of the present invention is disclosed.

Further advantages of the invention will be more clearly understood from the following description of illustrative embodiments thereof, to be read by way of example and not of limitation in conjunction with the apparatus shown. The beneficial effects described above apply generally to the ball cover disclosed herein. The specific structures through which these benefits are delivered will be described in detail hereinbelow.

### BRIEF DESCRIPTION OF THE DRAWINGS

The invention will now be described in greater detail in the following way of example only and with reference to the attached drawings, in which:

FIG. 1 is a front view of a vehicle showing the present invention built into or affixed to the rear view mirror(s) of the vehicle.

FIG. 2 is a front view of the vehicle showing the present invention mounted within the front headlights of the vehicle.

FIG. 3 is a front view of the vehicle showing the present invention mounted onto the windshield of the vehicle.

FIG. 4 is a front view of the vehicle showing the present invention mounted onto the roof of the vehicle.

FIG. 5 is a side view of the vehicle allowing the present invention attached to the side view mirrors, spoiler, fog lights, grill, hood, dashboard and side markers of the vehicle.

FIG. 6 is a top view of the vehicle allowing the present invention fastened to the bumper of the vehicle.

### MODE(S) FOR CARRYING OUT THE INVETION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention. Although those of ordinary skill in the art may readily recognize many alternative embodiments, especially in light of the illustrations provided herein, this detailed description is exemplary of the preferred embodiment of the present invention, the scope of which is limited only by the claims appended hereto.

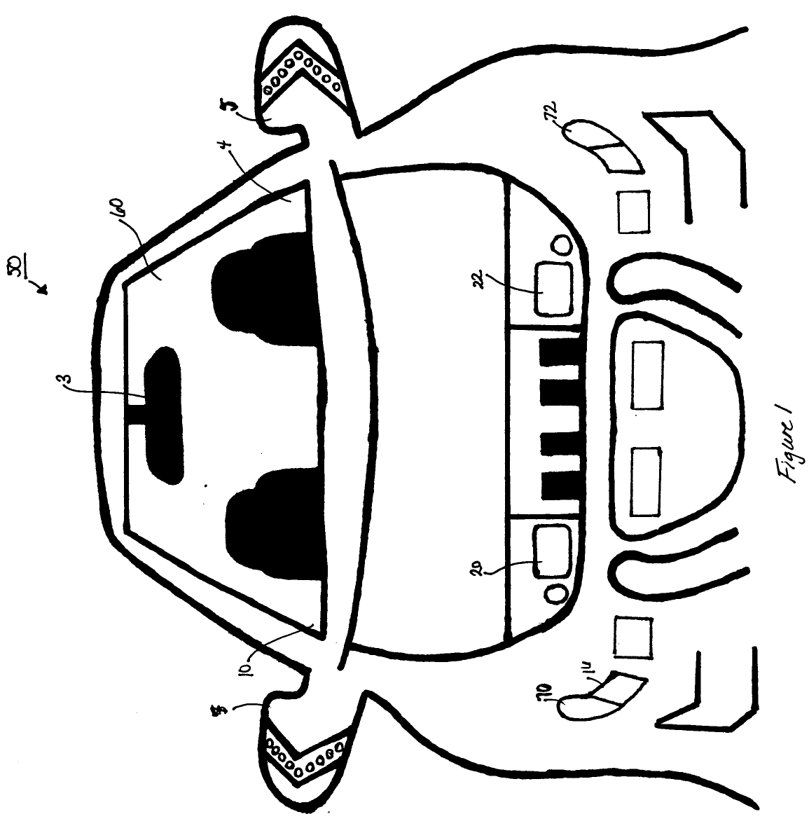

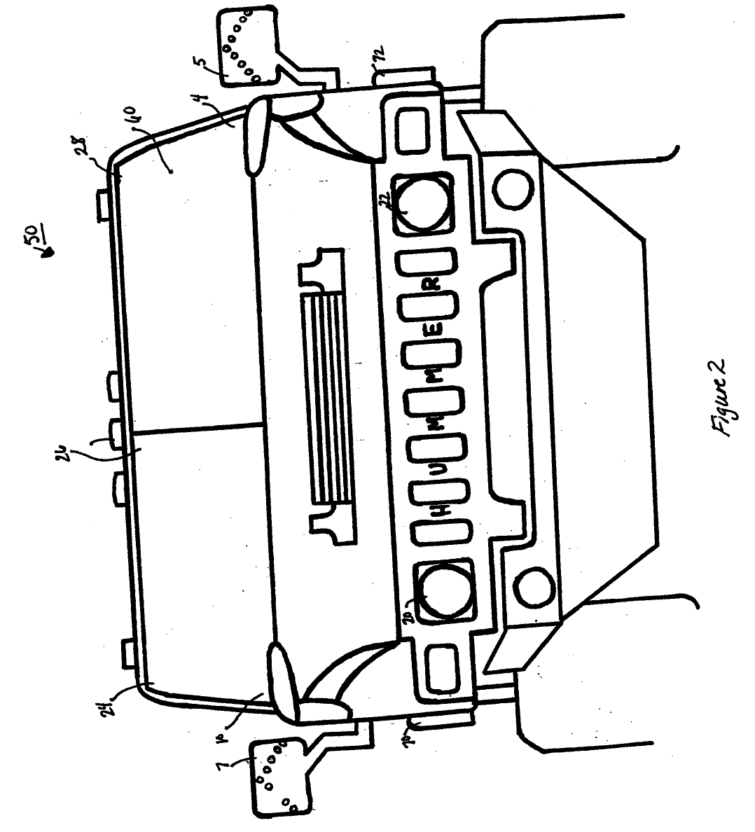

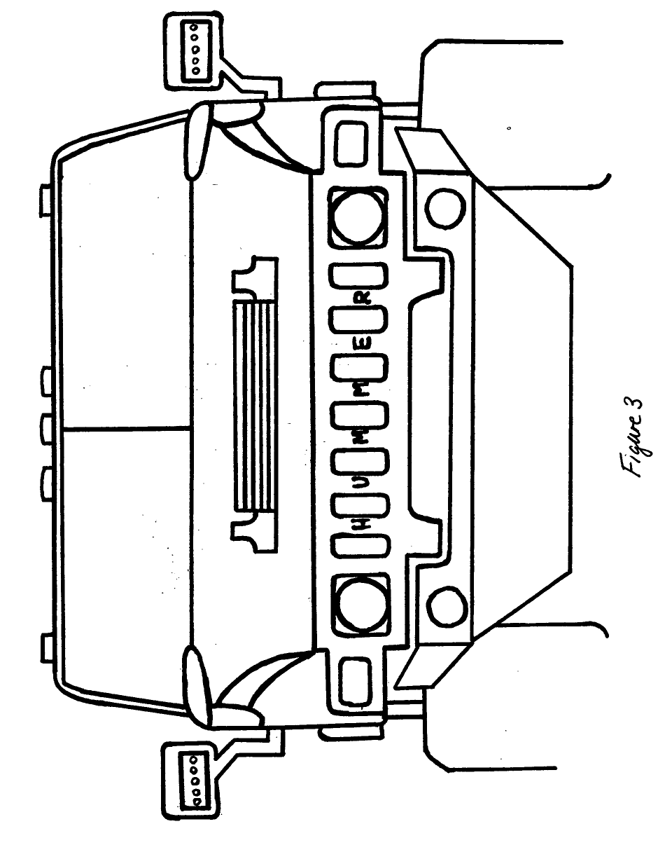

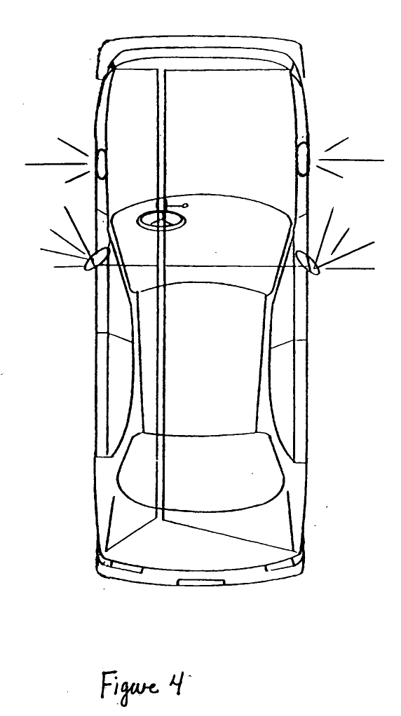

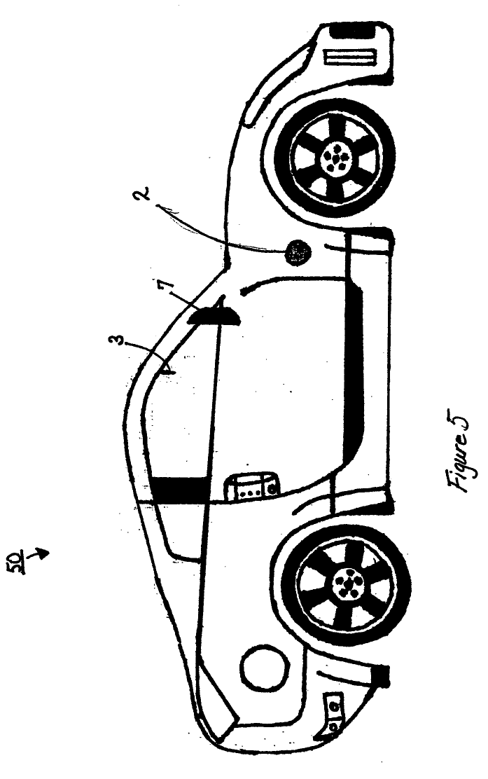

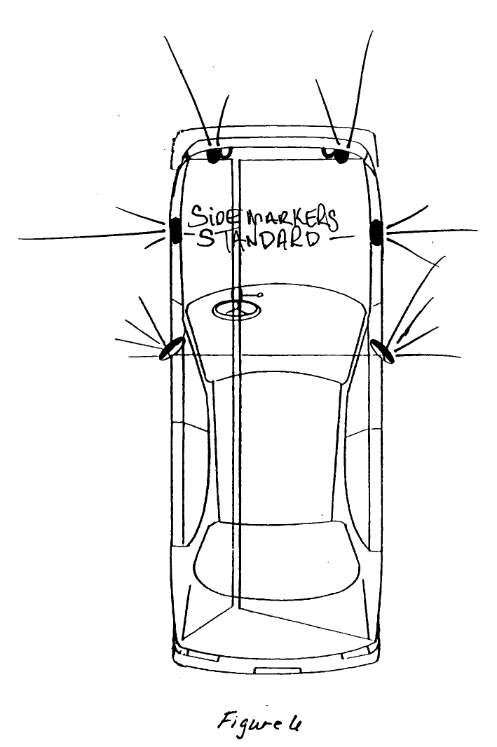

FIG. 1 is a front view of a vehicle 50 showing an indicator system 2 having a plurality of end points, where each end point incorporates at least one indicator. Preferably, FIGS. 1-6 show the indicator system 2 having a plurality of indicators positioned in various locations of the vehicle 50 and designed to signal a straight ahead direction. The locations of the indicator system 2 may include, but not be limited to, a dashboard, windshield, rearview mirror, side view mirrors, front bumper, front grill, hood, roof, spoiler area, fog lights, side markers and the like. Specifically, FIG. 1 depicts the indicator system 2 being built into or mounted onto a front surface of the rear view mirror 3 located within the interior of the vehicle 50. FIGS. 1-3 and 5 shows the indicator system 2 built into and mounted onto a front surface of side view mirrors 5, 7. FIGS. 1-3 illustrates the indicator system 2 being positioned at corners 4, 10 of a windshield 60. The indicators 4, 10 can be added to the vehicle 50 by the vehicle owner as an after market product, or can be built into the vehicle 50 by a manufacturer.

FIGS. 1-5 shows the vehicle 50 having an additional possible location for the indicator system 2 being positioned at the front headlight quadrant 12, 18. Headlights 20, 22 and turn signals 16, 20 are placed in their conventional position. Straight indicators 30, 32 are mounted adjacent to the turn indicators 34, 36. In an alternate embodiment, the straight ahead indicators can be installed on top of the front windshield 24, 26, 28.

Another possible location is to include the indicator system 2 in the front turn signal lights 70, 72 located at the side, front portion of the vehicle 50. In all cases, all indicators within the indicator system 2 will flash simultaneously. Here, a light source 20 of the indicator system 2 would flash on and off as is common with existing turn indicator devices. Obviously, there are other possible locations on the front facing surface of a vehicle that may be acceptable for placing the straight ahead signal indicator of the present invention. The electrical design of the indicators in all possible locations is such that both straight and turn indicators cannot be activated simultaneously.

In particular, each indicator 2 collectively includes a light source holder 17, a light source 20 and a housing 15 having a base and a lens being connected to one another by at least one fastener. The base has a perimeter wall which surrounds a cavity therein. The cavity is adapted to accept the light source holder 17 therein and an aperture allowing wiring from the light source holder to exit the base and be connected to the electrical system of the vehicle 50. Specifically, the light source holder 17 is fixedly positioned within the cavity of the base and is electrically connected to a signaling device 60.

The signaling device 60 is activated by the driver through a switch 30 connected to a turn indicator stem 33 or other device. The switch 30 may be activated by, but not limited to, a hand operated switch, a foot operated switch, a voice activated mechanism and/or a global positioning system (hereinafter called GPS system or GPS receiver). Operatively speaking, when the switch 30 is activated, it sends electrical current to the light source 20, thereby allowing the light source 20 to be turned on. The light source 20 may be connected to a flasher unit allowing the light source to emit intermittent light designed to flash for a determined period of time, such as ten seconds. The light source 20 is removably connected to the light source holder 17 and may come in the form of light emitting diodes, solar powered cells, lasers, reflectors, light bulbs, incandescent bulbs, battery operated lights, electric lights and the like. In turn, the signaling device 60 may be deactivated either manually at the discretion of the driver (such as by hand or foot), by voice or automatically by a mechanism, including but not limited to, GPS system recognizing the position change of the vehicle 50, accelerometer detecting the speed change of the vehicle 50 and the like.

The lens 22 is mounted onto a perimeter wall of the base and may be transparent, but is preferably tinted. In a preferred embodiment, the lens is tinted having the color green deemed as its universal sign for proceeding in a straight ahead manner. In the alternative, the lens of the housing 15 may include solar powered cells, namely photovoltaic cells, therein designed to act as the light source during the daytime hours. The photovoltaic cells maintain its basic structures generally including an anti-reflective coating, a contact grid, N-type silicone, P-type silicone and a back contact. A durable, non-glass cover plate is preferably placed on the anti-reflective coating in order to protect the solar-powered cells from being exposed to the elements.

In this embodiment, the photovoltaic cells convert the sunlight into electricity by absorbing the light and transferring the energy of the absorbed light to a semiconductor, whereby the energy frees electron-hole pairs. The photovoltaic cells include at least one electric field, thereby forcing freed electrons to migrate in a specified direction. Metal contacts are placed on polar opposite sides of the photovoltaic cells, thereby drawing current away to external use. When nighttime falls, the solar powered lens will cease and will rely on the light source 20 contained within the housing 15 as then means for illumination for the indicator system 2.

As the above description and illustrations show, the straight ahead signal indicator of the present invention can be placed in a variety of locations and can help drivers communicate with each other at an intersection to help tell other drivers that it is the intention of the vehicle to proceed in a straight direction.

While the invention has been described in connection with a preferred embodiment, it is not intended to limit the scope of the invention to the particular form set forth; however, it is intended to cover such alternatives, modifications, and equivalents as may be included within the spirit and scope of the invention as defined by the appended claims.

### INDUSTRIAL APPLICABILITY

The present invention finds specific industrial applicability in the automobile industry.

What is claimed and desired to be secured by Letters Patent is as follows:

1. A vehicle direction indicator system comprising:
at least one indicator having a housing, a light source holder attached within said housing, a light source being removably attached to said light source holder, and a lens being attached to a front portion of said housing;
said indicator system simultaneously emitting a light when a vehicle driver actuates a signaling device from within a vehicle;
said indicator system built into or affixed to a front portion of said vehicle and powered by an electrical system of said vehicle;
said indicator system functioning in an intermittent manner and capable of telling other drivers at a four way intersection that said signaling vehicle is moving in a straight direction.

2. The indicator system as recited in claim 1, wherein said system is mounted adjacent to a turn signal of said vehicle.

3. The indicator system as recited in claim 1, wherein said system is mounted within said vehicle on a left side and a right side of a windshield.

4. The indicator system in claim 1, wherein said system is mounted in an integral fashion within front headlights of said vehicle.

5. The indicator system as recited in claim 1, wherein said system is mounted within a forward portion of at least one side view mirror of said vehicle.

6. The indicator system as recited in claim 2, wherein said system is designed not to operate simultaneously with said turn signal of said vehicle.

7. The indicator system as recited in claim 1, wherein said system is affixed to or built into said front facing portion of a rear view mirror of said vehicle.

8. The indicator system as recited in claim 1, wherein said system has a plurality of end points, where each end point is affixed in a location consisting of a roof, a spoiler, a bumper, fog lights, grill, hood, side markers and a dashboard.

9. The indicator system as recited in claim 1, wherein said indicators will flash simultaneously with one another.

10. The indicator system as recited in claim 1, wherein said light source is made from a material consisting of light emitting diodes, solar powered cells, lasers, reflectors, light bulbs, incandescent bulbs, battery operated lights and electric lights.

11. A vehicle direction indicator system comprising:
at least one indicator having a housing including a base and being connected to a lens by at least one fastener, wherein said base has a cavity surrounded by a perimeter wall and an aperture;
said cavity is capable of accepting a light source holder therein;
wiring from said light source holder being connected to a signal device within a vehicle; and
a light source being removably attached to said light source holder.

12. The indicator system as recited in claim 11, wherein said signaling device is a switch having an activation and deactivation means consisting of a hand operated switch, a foot operated switch, a voice activated mechanism and a global positioning system.

13. The indicator system as recited in claim 11, wherein said light source is connected to a flasher unit allowing said light source to emit an intermittent light.

14. The indicator system as recited in claim 11, wherein said light source is made from a material consisting of light emitting diodes, solar powered cells, lasers, reflectors, light bulbs, incandescent bulbs, battery operated lights and electric lights.

15. The indicator system as recited in claim 11, wherein said lens incorporates solar powered cells therein to act as its own light source during daytime hours.

16. The indicator system as recited in claim 11, wherein said lens is tinted in a green color indicating a straight ahead direction.

17. The indicator system as recited in claim 11, wherein said indicator system is attached to a front portion of said vehicle.
